(19) United States
(12) Patent Application Publication
(10) Pub. No.: US 2014/0010241 A1
(43) Pub. Date: Jan. 9, 2014

(54) Method for Controlling an Installation with Real-Time Transmission of Datagrams

(71) Applicant: Robert Bosch GmbH, Stuttgart (DE)

(72) Inventors: Ludwig Leurs, Lohr-Steinbach (DE); Eberhard Schemm, Lohr Am Main (DE)

(73) Assignee: Robert Bosch GmbH, Stuttgart (DE)

(21) Appl. No.: 13/716,115

(22) Filed: Dec. 15, 2012

(30) Foreign Application Priority Data
Dec. 16, 2011 (DE) 10 2011 121 522.4

(51) Int. Cl. H04L 12/911

(52) U.S. Cl. CPC H04L 47/821
USPC 370/468

(57) ABSTRACT

A method for controlling an installation, wherein a controller controls at least one first installation unit and a second installation unit and wherein a real-time bus is used for communication between the at least one first installation unit and the controller, and communication between the controller and the at least one first installation unit is effected via real-time datagrams. The controller conveys datagrams to the second installation unit via the real-time bus, these datagrams being conveyed via a non-real-time channel and these datagrams being prioritized with respect to other messages sent via the NRT section of the real-time bus.

This application claims priority under 35 U.S.C. §119 to patent application no. DE 10 2011 121 522.4, filed on Dec. 16, 2011 in Germany, the disclosure of which is incorporated herein by reference in its entirety.

### BACKGROUND

The present disclosure relates to a method for controlling an installation and to a corresponding machine installation. From the prior art, the most varied methods for controlling installations are known. These installations can be, for example, machine tools or the like. In such control systems, the problem is often that real-time conditions must be adhered to also in the case of an Ethernet connection even when a transportation, for example of EIP messages, takes place via an NRT (Non-Real-Time) channel.

The disclosure thus relates especially to such machines and installations which are operated with a real-time Ethernet field bus. From the prior art, it is known to use two or more such real-time field buses. Thus, for example, two RTE (Real-Time Ethernet) masters are used. Both masters are cabled separately to their slaves or devices, respectively. This requires not only two masters but also separate cablings and infrastructure components.

The present disclosure is based on the object, therefore, of simplifying the structures for such a device. According to the disclosure, this object is achieved by a method and a machine installation as described herein.

### SUMMARY

In a method according to the disclosure for controlling an installation, a controller controls at least one first installation unit and one second installation unit and a real-time (field) bus is used for communication between the first installation unit and the controller.

Furthermore, communication between the controller and the first installation unit is effected via real-time datagrams which, in particular, are communicated via this real-time (field) bus.

According to the disclosure, the controller conveys datagrams to the second installation unit via the real-time field bus, these datagrams being conveyed via a non-real-time channel and these datagrams being prioritized with respect to other messages sent via the real-time (field) bus. Therefore, a combination of real or hard real time (for example in the form of SERCOS III), on the one hand, and the prioritization of messages in an NRT channel originally planned for non-real-time (especially of SERCOS III) is proposed.

Due to this procedure, control can be carried out via only one real-time bus, more precisely due to the fact that prioritization of the messages transmitted in the NRT channel takes place and due to this prioritization, a (virtual) real-time transmission of such messages is also enabled.

Advantageously, the datagrams are Ethernet datagrams. The Ethernet technology provides for an exchange of data in the form of data packets between the devices connected in a local area network such as, for example, computers, printers or also machine components.

In a preferred method, the control is an SPC (stored-program control). Furthermore, the datagrams are conveyed preferably to the first installation unit via a real-time channel.

Due to the procedure according to the disclosure, the variety of devices to which a control can be connected can be increased. More precisely, the possible devices which are connected to two real-time Ethernet buses in the prior art can thus be combined. This makes it possible, on the one hand, to achieve more flexible cabling and, on the other hand, also cost saving in the control.

The prioritization is preferably also understood to be a temporal prioritization of certain datagrams. This temporal prioritization makes it possible to ensure for these datagrams that they are also conveyed under real-time conditions. The prioritized datagrams are thus advantageously (temporally) sent before other datagrams via the non-real-time channel.

In a preferred method, datagrams conveyed via the non-real-time channel to the second installation unit are identified from a plurality of datagrams conveyed via the non-real-time channel by means of at least one predetermined feature of these datagrams. The especially subsequent prioritization of these datagrams can be achieved by means of this identification.

In a further advantageous method, the predetermined feature is selected from a group of features which contains a VLAN tag of this datagram, a DSCP field in an IP header of this datagram, an Ethernet type of the datagram, TCP/UDP port number, combinations thereof or the like. Thus, it is possible to allocate this Ethernet message, for example, by means of the VLAN tag or its evaluation in the Ethernet message. The other possibilities of evaluation also allow an allocation of the respective datagrams.

In a further advantageous method, the datagrams conveyed in prioritized manner via the non-real-time channel of a second installation unit are conveyed under real-time conditions. This real-time transmission is possible due to the prioritization of these datagrams.

By means of a further advantageous method, datagrams are also conveyed under non-real-time conditions via the non-real-time channel.

In a further advantageous method, the prioritization is dynamically adapted. Thus, the prioritization can be adapted rapidly to the respective situations on the control side.

In a further advantageous method, at least one installation unit has a servomotor. The first installation unit advantageously has a servomotor. Thus, it would also be possible that several servomotors are controlled via the real-time bus. In this context, the second installation unit can also have motors such as servomotors, but also motors with frequency inverters or the like. However, other devices (actuators and/or sensors) can also be driven such as, for example, laser scanners or the like. In addition, it would be possible that several input/output devices (standard I/O) are driven via the real-time bus.

The present disclosure is also directed to a machine installation having at least one first installation unit and one second installation unit, wherein the first installation unit and the second installation unit are controllable preferably independently of one another.

Furthermore, the machine installation has a controller which controls both the first installation unit and the second installation unit.

According to the disclosure, the controller communicates both with the first installation unit and with the second installation unit via the same real-time field bus, the communication with the first installation unit being effected via real-time datagrams and furthermore an evaluating device being provided which prioritizes from a multiplicity of datagrams output by the controller via a non-real-time channel certain datagrams in order to thus achieve real-time conditions for these (i.e. especially the prioritized) datagrams transmitted via the non-real-time channel.

The evaluating device is preferably arranged in at least one device which is connected to the said real-time bus and which itself preferably feeds messages into the non-real-time channel. This device can be, for example, an NRT plug. This prioritization can here occur via at least one, but preferably via a number of queues. In this context, e.g., the highest priority can be allocated to a temporal synchronization, a subsequent priority to a motion synchronization, a further priority to safety criteria, etc.

In particular, datagrams are prioritized which are used for controlling the second installation unit.

In this context, a communication occurs advantageously via Ethernet. Only a real-time bus is therefore necessary for controlling the first and the second installation unit.

At least one installation unit preferably has a servomotor.

### BRIEF DESCRIPTION OF THE DRAWINGS

Further advantages and embodiments are obtained from the drawings attached, in which:

FIGS. 1a, 1b show two representations of circuit arrangements according to the prior art;

FIG. 2 shows a representation of a circuit arrangement according to the disclosure in a line topology;

FIG. 3 shows a representation of a circuit arrangement according to the disclosure in a ring topology;

FIG. 4 shows a diagrammatic representation of a datagram; and

FIGS. 5a, 5b show two further representations for illustrating a datagram.

### DETAILED DESCRIPTION

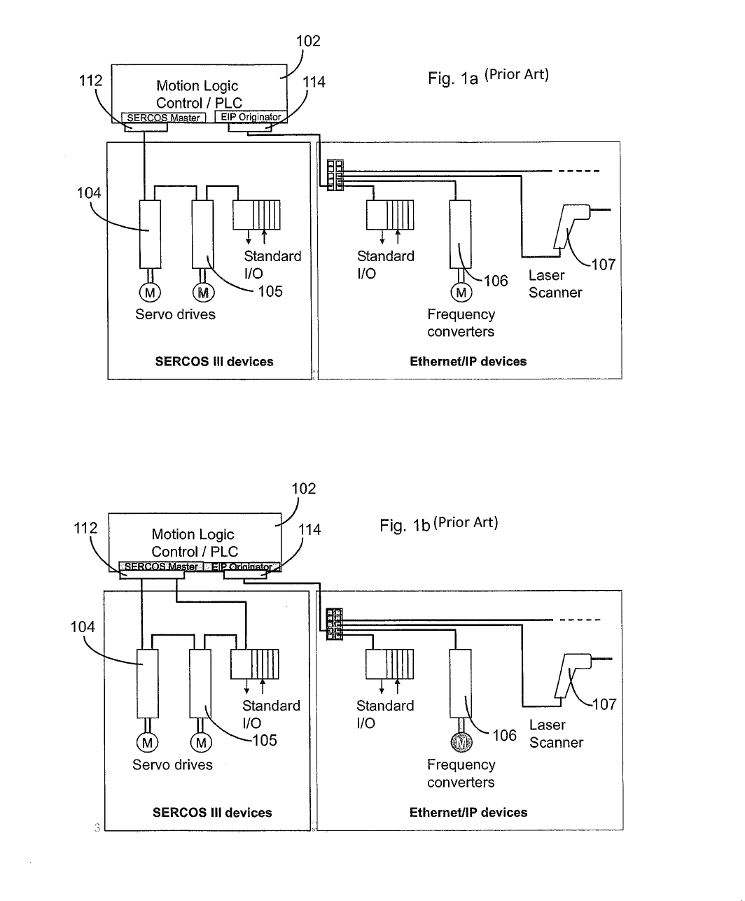

FIGS. 1a and 1b show two diagrammatic representations of circuits according to the prior art. In this context, a controller 102 is provided which controls a multiplicity of installation units 104 to 107. Controlling these installation units 104 to 107 requires interfaces or buses 112 and 114, respectively. It can be seen that the individual installation units 104 and 105, on the one hand, and the installation units 106 and 107, on the other hand, are controlled completely separately. In this context, figure la illustrates the representation for a line topology and figure lb illustrates the representation for a ring topology. Thus, two separate buses are necessary in each case in these two representations.

In other words, for example SERCOS III devices, on the one hand, and Ethernet/IP devices, on the other hand, are operated here with separate networks.

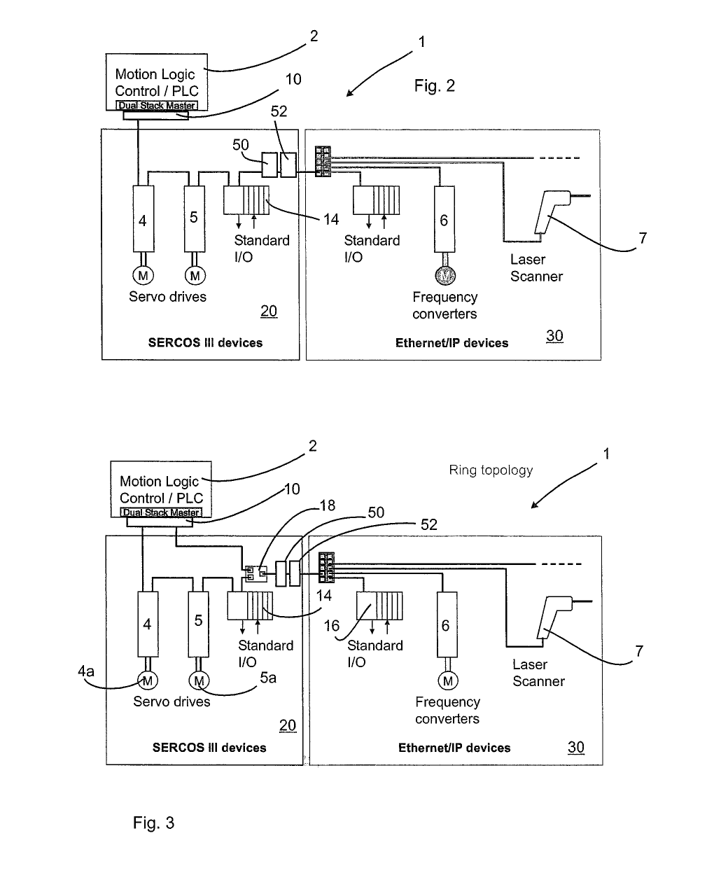

FIG. 2 shows the representation of an arrangement according to the disclosure for the case of a line topology. In this case, installation units 4 and 5, in this case servomotor drives, are provided. The reference symbols 4a and 5a in each case relate to servomotor drives or servomotors, respectively. These installation units are in this case SERCOS III devices which are in each case operated in real time as illustrated by module 20. The reference symbol 2 in turn identifies a controller for driving these installation units. Furthermore, a real-time bus 10 is thus also provided via which datagrams are conveyed to the installation units 4 and 5.

However, the same real-time bus 10 also drives the installation units 6 and 7 which are allocated to a module 30 and which are Ethernet and IP devices, respectively. The reference symbols 14 and 16 relate to an input and output device in which case both digital and analog inputs and outputs can be provided here. The installation units 4 and 5 shown are here SERCOS III devices which can be operated on a synchronous SERCOS bus. However, they can also be arbitrary devices. These do not necessarily need to operate synchronously. However, the installation units in this case have communication elements such as communication chips which can operate synchronously in accordance with a SERCOS specification.

The reference symbol 50 relates to an evaluating unit (only shown roughly diagrammatically) which evaluates the datagrams sent via the NRT channel. In this context, this evaluating unit 50 can detect or identify especially those datagrams which are used for controlling the installation units 6, 7. The reference symbol 52 identifies a prioritizing device which prioritizes temporally these datagrams which are used for controlling the installation units 6, 7, especially as preceding in the time sequence. Thus, this prioritizing device 52 can also effect a repositioning of the datagrams, in particular.

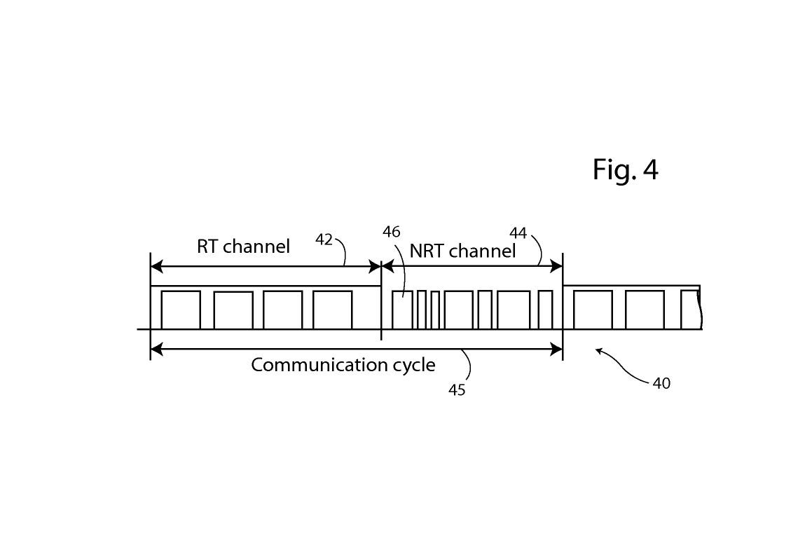

The evaluating unit 50 and the prioritizing device 52 are shown here as separate elements. Preferably, however, these facilities are arranged in at least one device which is connected to the said real-time bus and which itself preferably feeds messages into the non-real-time channel. In the arrangement shown in FIG. 3, the evaluating unit 50 and the prioritizing device can be arranged correspondingly in the NRT plug 18 (see below), in the embodiment shown in FIG. 2 perhaps in the input/output device 14. Furthermore, corresponding evaluating units and prioritizing devices could also be arranged in the installation units 4-7 or 4 and 5 respectively, especially if these themselves feed in datagrams.

It can be seen that the installation units do not necessarily need to be motors or electromotive drives.

The reference symbol 12 identifies a distributing device which distributes the connections to the individual installation units 6 and 7. Apart from the installation units shown, even more installation units could be connected both among the SERCOS III devices and among the Ethernet devices. The reference symbol 1 refers to the machine installation in its totality.

FIG. 3 shows a representation corresponding to the representation from FIG. 2 but for a ring topology. This ring topology can be recognized here especially with regard to the module 20. The reference symbol 18 identifies an NRT plug. SERCOS devices usually have two Ethernet plugs each. If a physical ring is set up (i.e. from the last device, an Ethernet cable goes back to the controller 2), then this NRT plug is needed in order to couple further devices with the additional real-time protocol. Such an NRT plug has two ports for SERCOS connections and one port for standard Ethernet. It thus advantageously couples the standard Ethernet out of the SERCOS NRT time window and outputs the messages at an NRT port. Furthermore, it feeds the messages of an NRT port advantageously into the time window of SERCOS, reserved for NRT. As is illustrated in FIGS. 2 and 3, the different installation units can be controlled in this manner both for a ring topology and for a line topology with the aid of only one real-time bus.

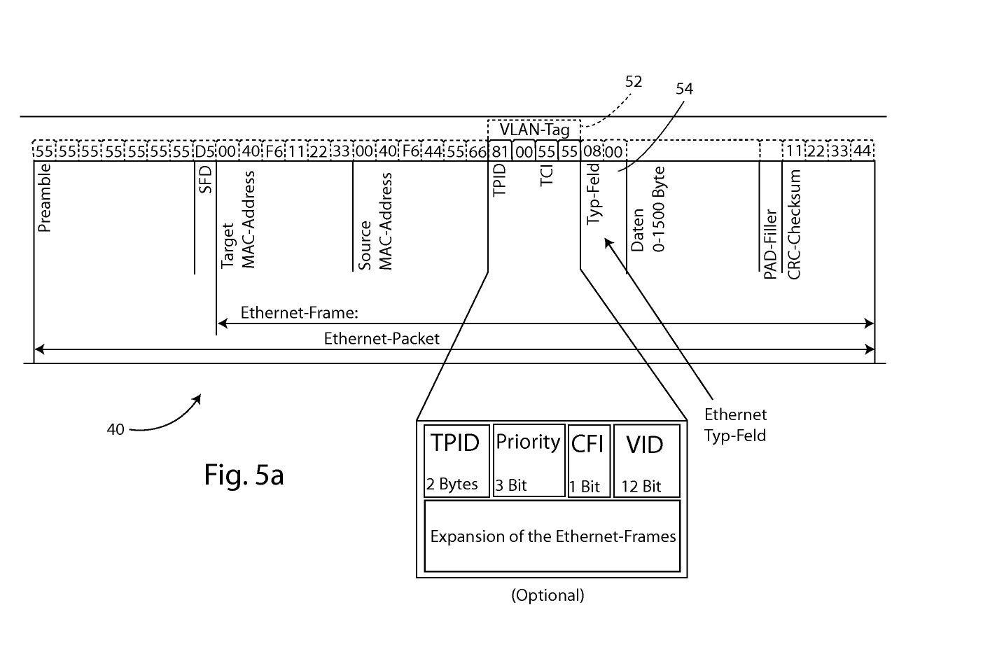

FIG. 4 shows the diagrammatic representation of a datagram 40. This datagram has here a real-time channel (real-time channel 42) and a non-real-time channel 44. The reference symbol 45 identifies the communication cycle in its entirety. According to the disclosure, it is proposed that the message sections transmitted within the non-real-time channel 44 are prioritized, i.e. those sections which are intended to be conveyed to the installation units 6 and 7 shown in FIGS. 2 and 3. By this means, a real time is achieved via TDMA (time division multiple access) in the real-time channel 42, and via a prioritization in the non-real-time channel 44.

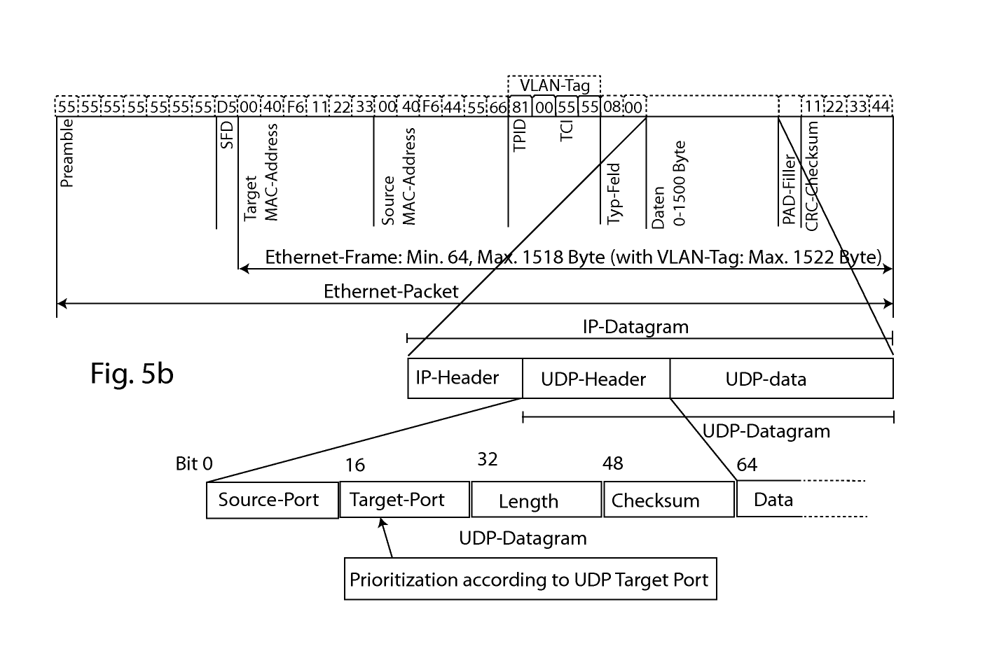

FIGS. 5a and 5b illustrate datagrams for representing this prioritization. In the representation shown in FIG. 5a, a datagram is identified by means of its VLAN tag. The reference symbol 54 identifies an Ethernet type field which is also suitable for individualizing and thus for prioritizing.

In the representation shown in FIG. 5b, an IP datagram is also listed. A prioritization can be carried out here after the IP header. Furthermore, it is also possible to carry out this individualization or prioritization after the UDP header, for example after the number of a destination port as illustrated in FIG. 5b. These datagrams, thus individualized, are prioritized during the transmission as mentioned above so that a real-time transmission is correspondingly possible also for these datagrams.

The applicant reserves the right of claiming all features disclosed in the application documents as essential to the disclosure if they are novel with respect to the prior art individually or in combination.

### LIST OF REFERENCE DESIGNATIONS

1 Machine installation
2 Control device
3 Installation unit
4a Servomotor drive
5 Installation unit
5a Servomotor drive
6 Installation unit
7 Installation unit
10 Real-time field bus
12 Distribution device, non-real-time channel
14 Input and output device, evaluating device
16 Input and output device
18 NRT plug
20 Module
30 Module
40 Datagram
42 Real-time channel
44 Non-real-time channel
45 Communication cycle
50 Evaluating device
52 Prioritizing device
54 Ethernet type field
102 Controller
104 Drive unit, installation unit
106 Drive unit, installation unit
112 Interface, bus
114 Interface, bus

What is claimed is:

1. A method for controlling an installation, comprising:
controlling at least one first installation unit and a second installation unit with a controller;
communicating between the at least one first installation unit and the controller with a real-time bus;
effecting communication between the controller and the at least one first installation unit with real-time datagrams; and
conveying the datagrams to the second installation unit with the controller via the real-time bus,
wherein the datagrams are conveyed via a non-real-time channel, and
wherein the datagrams are prioritized with respect to other messages sent via the non-real-time channel of the real-time bus.

2. The method according to claim 1, wherein the datagrams conveyed via the non-real-time channel to the second installation unit are identified from a plurality of datagrams conveyed via the non-real-time channel by means of at least one predetermined feature of these datagrams.

3. The method according to claim 2, wherein the predetermined feature is selected from the group of features consisting of a VLAN TAG of this datagram, a DSCP field in an IP header of this datagram, the Ethernet type of the datagram, TCP/UDP port number, and combinations thereof or the like.

4. The method according to claim 1, wherein the datagrams conveyed to the second installation unit via the non-real-time channel are conveyed under real-time conditions.

5. The method according to claim 1, wherein the prioritization is dynamically adapted.

6. The method according to claim 1, wherein at least one of the at least one first installation unit and the second installation unit has a servomotor.

7. A machine installation comprising:
at least one first installation unit; and
a second installation unit,
wherein the at least one first installation unit and the second installation unit are controllable, with a controller which controls both the at least one first installation unit and the second installation unit,
wherein the controller communicates both with the at least one first installation unit and with the second installation unit via the same real-time bus,
wherein the communication with the at least one first installation unit is effected via real-time datagrams,
wherein an evaluating device is configured to prioritize from a multiplicity of datagrams conveyed via a non-real-time channel from the controller to the second installation unit certain datagrams in order to thus achieve real-time conditions for these datagrams transmitted via the non-real-time channel.

8. The machine installation according to claim 7, wherein at least one of the at least one first installation unit and the second installation unit has a servomotor.
